(19) United States
(12) Patent Application Publication
(10) Pub. No.: US 2009/0145875 A1
(43) Pub. Date: Jun. 11, 2009

(54) Bottle cap for a bird feeder

(76) Inventor: Stewart C. Gardner, Mansfield, MA (US)

Correspondence Address: Steven S. Payne, P.O. Box 65024, Washington, DC, 20035, US

(21) Appl. No.: 11/999,822

(22) Filed: Dec. 7, 2007

(51) Int. Cl. A01K 39/01; B65D 39/00

(52) U.S. Cl. 215/228; 119/51.01

(57) ABSTRACT

A bottle cap for fitting on a mouth of a bottle to form a bird feeder is disclosed. The bottle cap comprises a first chamber with an opening for receiving the mouth of the bottle and a bottom, wherein threads are provided on an inner wall of the first chamber so that the cap can be screwed onto the mouth of the bottle. A second chamber with a closed bottom is provided. An extension tube extends from the bottom of the first chamber at least partially into the second chamber, wherein liquid moves between the first and second chambers through the extension tube. At least one feeding port is provided in a side wall of the second chamber. At least one vent hole is provided in the second chamber for allowing air to be vented from the second chamber.

### FIELD OF THE INVENTION

The present invention relates generally to bird feeders. More particularly, the present invention relates to a bottle cap and a bottle for use as a hummingbird feeder.

### BACKGROUND OF THE INVENTION

Millions of people around the world enjoy watching and feeding wild birds. These people love to feed the wild birds in their backyards or on their balconies so that they can enjoy watching the birds. While there are many types of wild birds that people like to watch and feed, the hummingbird is a favorite for many people. Hummingbirds are attracted to sweet nectar produced by flowers. As a substitute for the sweet nectar, people use water sweetened by sugar in hummingbird feeders to attract and feed the hummingbirds.

A typical hummingbird feeder is comprised of a fluid reservoir for holding the sugar water which is conveyed to a plurality of simulated flowers. The hummingbirds insert their long thin beak into holes in the simulated flowers to drink the sugar water. While the sugar water is an effective substitute for natural flower nectar, the use of sweetened water has several drawbacks.

In warm climates, the sweetened water has a tendency to ferment which can quickly lead to the production of bacteria, mold and mildew. The bacteria, mold and mildew will discolor the sweetened water and may begin to grow inside the fluid reservoir. As a result, the hummingbird feeder can quickly turn into an unsightly mess. In addition, the bacteria, mold and mildew can also be harmful and fatal to the hummingbirds. As a result, hummingbird feeders must be cleaned on a regular basis, for example, every three or four days. The constant hassle of cleaning the hummingbird feeder has caused many people to stop using their hummingbird feeders.

Another problem with known hummingbird feeders is that they have a tendency to leak. Not only is this a waste of sugar water but the leaked sugar water tends to attract unwanted insects such as bees and ants.

Thus, there is a need for a new hummingbird feeder which overcomes the problems cited above.

### SUMMARY OF THE INVENTION

It is therefore a feature and advantage of the present invention to provide a hummingbird feeder which requires minimal or no cleaning at all.

According to one aspect of the invention, a bottle cap is provided with at least one feeding port, wherein the bottle cap can be screwed onto a plastic bottle thereby turning most plastic bottles into a hummingbird feeder.

According to another aspect of the invention, a disposable plastic bottle with a cap with at least one feeding port is disclosed which is pre-filled with a nectar to create a hummingbird feeder.

In accordance with one embodiment of the present invention, a bottle cap for fitting on a mouth of a bottle is disclosed. The bottle cap comprises: a first chamber with a opening for receiving the mouth of the bottle and a bottom, wherein threads are provided on an inner wall of the first chamber so that the cap can be screwed onto the mouth of the bottle; a second chamber with a closed bottom; an extension tube extending from the bottom of the first chamber at least partially into the second chamber, wherein liquid moves between the first and second chambers through the extension tube; at least one feeding port in a side wall of the second chamber; and at least one vent hole in the second chamber for allowing air to be vented from the second chamber.

In accordance with one embodiment of the present invention, a bottle cap for fitting on a mouth of a bottle is disclosed. The bottle cap comprises: a first apparatus comprising: a first chamber with a opening for receiving the mouth of the bottle and a bottom, wherein threads are provided on an inner wall of the first chamber so that the cap can be screwed onto the mouth of the bottle; an extension tube extending from the bottom of the first chamber at least partially into the second chamber, wherein liquid moves between the first and second chambers through the extension tube; at least one vent hole in the second chamber for allowing air to be vented from the second chamber; a second apparatus comprising: a second chamber with a closed bottom; at least one feeding port in a side wall of the second chamber.

In accordance with one embodiment of the present invention, a bird feeder is disclosed. The bird feeder comprises: a fluid reservoir and a mouth; a first chamber with a opening for receiving the mouth of the bottle and a bottom, wherein threads are provided on an inner wall of the first chamber so that the cap can be screwed onto the mouth of the bottle; a second chamber with a closed bottom; an extension tube extending from the bottom of the first chamber at least partially into the second chamber, wherein liquid moves between the first and second chambers through the extension tube; at least one feeding port in a side wall of the second chamber; and at least one vent hole in the second chamber for allowing air to be vented from the second chamber.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

The invention will now be described, by way of example, with reference to the accompanying drawings, wherein:

FIG. 1 illustrates a side view of a bottle cap according to one embodiment of the invention;

FIG. 2 illustrates a side perspective view of the bottle cap illustrated in FIG. 1 according to one embodiment of the invention;

FIG. 3 illustrates a side view of a bottle cap according to one embodiment of the invention;

FIG. 4(a) illustrates a side view of a bottle cap with two straight sides according to one embodiment of the invention;

FIG. 4(b) illustrates a side view of a bottle cap with circular sides according to one embodiment of the invention;

FIG. 5 illustrates a side view of a bottle cap with a perch according to another embodiment of the invention;

FIG. 6(a) illustrates a top view of a bottle cap with a ring perch according to another embodiment of the invention;

FIG. 6(b) illustrates a side view of a bottle cap with a perch with two stems according to one embodiment of the invention;

FIG. 7 illustrates a side view of a first section of the bottle cap according to one embodiment of the invention;

FIG. 8(a) illustrates a side view of a second section of the bottle cap with two straight sides according to another embodiment of the invention;

FIG. 8(b) illustrates a side view of a second section of the bottle cap with circular sides; and

FIG. 9 illustrates a side view of a hummingbird feeder according to another embodiment of the invention.

### DETAILED DESCRIPTION OF PREFERRED EMBODIMENTS OF THE INVENTION

According to one embodiment of the invention, a bottle cap is provided with at least one feeding port, wherein the bottle cap can be screwed onto a plastic bottle thereby turning most plastic bottles into a hummingbird feeder. In this embodiment, when the feeder needs to be cleaned, the bottle is simply thrown away and a new bottle is used. Thus, only the bottle cap needs to be cleaned if not thrown away as well. According to another embodiment of the invention, a disposable plastic bottle with a cap with at least one feeding port is disclosed which is pre-filled with a nectar, such as water mixed with a pure white sugar solution to create a hummingbird feeder. In this embodiment, the entire feeder is disposable and is thrown away when the nectar is gone or the feeder needs to be cleaned. Thus, the hassle of cleaning the feeder is completely eliminated.

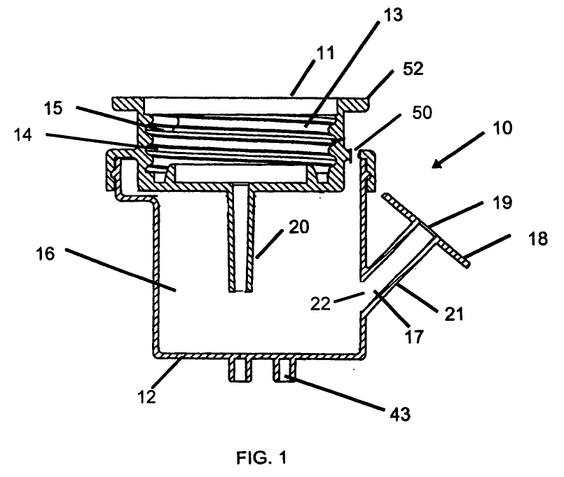

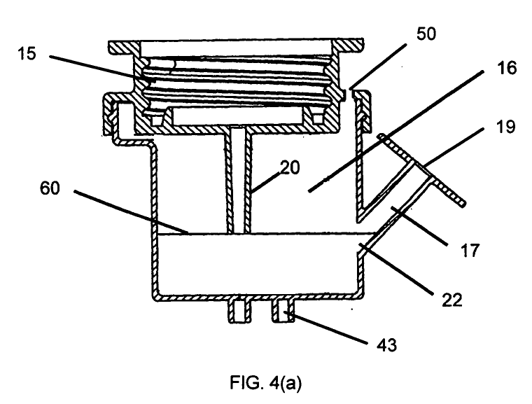

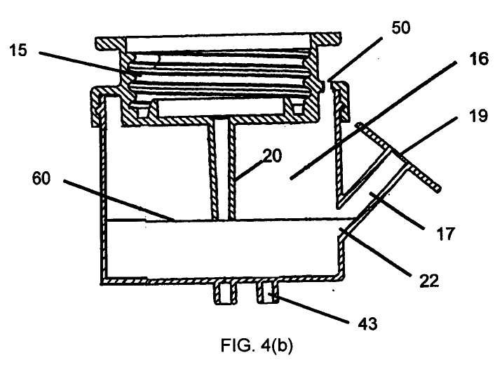

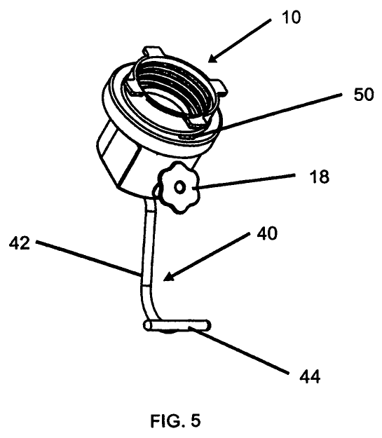

FIGS. 1-3 illustrate a various views of a bottle cap 10 according to one embodiment of the invention. The bottle cap 10 comprises an opening 11 and a side wall 13 with threads 14 so as to allow the bottle cap 10 to be screwed onto the mouth of a bottle (not illustrated). The bottle cap 10 has a bottom 12. The bottle cap 10 is divided into two fluid chambers 15, 16. It will be understood that the two fluid chambers 15, 16 may have various shapes and sizes and the invention is not limited thereto. The two fluid chambers 15, 16 are connected together by an extension tube 20. The extension tube 20 extends from the bottom of the first chamber 15 at least partially and more preferably at least half way into the second chamber. It will be understood by those skilled in the art that fluid is allowed to travel between the two fluid chambers 15, 16 through the extension tube when the bottle cap 10 is attached to the bottle. The bottle cap 10 also comprises at least one vent hole 50 for providing an air vent for the second chamber 16. According to one embodiment of the invention, it is important to the operation of the bottle cap that the vent hole 50 is located at the top of the second chamber 16. In another embodiment of the invention, the vent hole may be in the side of the second chamber. The operation of the vent hole 50 will be described in detail below with reference to FIG. 4. In addition, the bottle cap 10 may have a plurality of stabilizing fins 52 for holding the bottle in a proper position when the bottle is inserted into a hanging device.

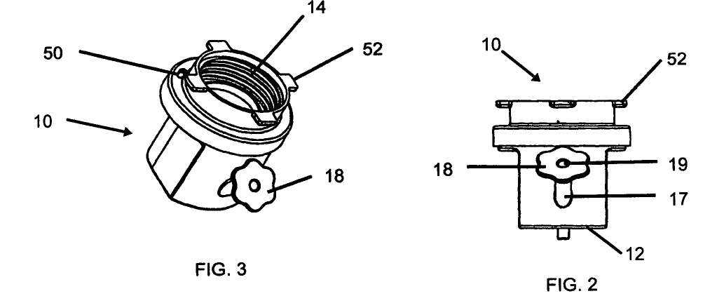

Returning to FIG. 1, the bottle cap 10 has at least one feeding port 21. It will be understood by those skilled in the art that the bottle cap 10 may have any number of feeding ports 21 and the invention is not limited to any specific number. In this embodiment of the invention, each feeding port 21 is comprised of a hollow stem 17, a simulated attractor 18, wherein the simulated attractor 18 has at least one opening 19. As illustrated in FIGS. 2-3, the simulated attractor 18 can have the shape and appearance of a flower or other ornamental shape but the invention is not limited thereto. The stem 17 is connected to an opening 22 in the side wall 13 of the second chamber 16 so that fluid in the second chamber 16 can pass into the hollow stem 17. The hollow stem 17 has a sufficient width so as to allow a hummingbird to stick his beak through the opening 19 into the hollow stem 17 to drink the nectar. In addition, the hollow stem 17 has a sufficient length, for example, ¼ to ¾ of an inch, so as to prevent the nectar from simply flowing out of the opening 19. It will be understood by those skilled in the art that the hollow stem 17 can have various lengths depending in part by the diameter of the hollow stem 17 and the invention is not limited thereto. Furthermore, the interior of the hollow stem 17 may be cylindrical as illustrated in FIG. 4(a) or elliptical as illustrated in FIG. 4(b) and the invention is not limited thereto. As a result, the opening 19 may either be circular or elliptical in shape but the invention is not limited thereto. In addition, the inner diameter of the hollow stem may be tapered near the opening 22 and get larger as the stem 17 gets closer to the opening 19.

According to one embodiment of the invention, the hollow stem 17 projects outward from the bottle cap 10 and the hollow stems 17 are angled upward from a position parallel to the bottom 12 of the bottle cap 10 so as to help prevent the nectar from leaking out of the openings 19. According to one embodiment of the invention, the hollow stem 17 is angled upward from a position parallel to the bottom 12 of the bottle cap 10 by at least 20 degrees, and preferably by greater than 40 degrees. It will be understood by those skilled in the art that the hollow stems 17 can be angled upward relative to the bottom 12 at any angle and the invention is not limited thereto.

As described above, the second chamber 16 may have various shapes. FIG. 4(a) illustrates a second chamber 16 with 2 rounded and two straight sides, while FIG. 4(b) illustrates a second chamber 16 with circular sides but the invention is not limited thereto. As illustrated in FIGS. 4(a)-(b), when the first and second chambers 15, 16 are under substantially the same pressure, the liquid level 60 in the second chamber substantially corresponds to the bottom of the extension tube. Thus, by lengthening and shortening the length of the extension tube, the level of the liquid in the second chamber can be raised and lowered. According to one embodiment of the invention, the bottom of the opening 22 is preferably positioned slightly below the bottom of the extension tube 20 so as to allow liquid to enter at least a portion of the hollow stem 17. When the pressure in the first chamber increases due to, for example, the heating of the bottle of liquid by the sun, the level of the liquid in the second chamber 16 will rise. By providing the vent hole(s) 50 in the second chamber 16, some of the air in the second chamber 16 can escape through the vent hole(s) 50 thereby reducing the pressure in the second chamber 16. If the vent hole(s) 50 were not provided, the increased pressure in the second chamber 16 would cause the liquid to advance up the hollow stem 17 and most likely leak out the opening 19. As mentioned above, the vent hole(s) 50 are preferably provided at the top of the second chamber. According to another embodiment of the invention, the vent hole(s) 50 are preferably provided in the second chamber anywhere above the height of the opening 19 in the simulator attractor 19.

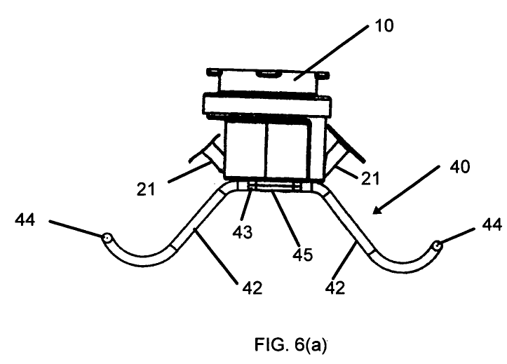

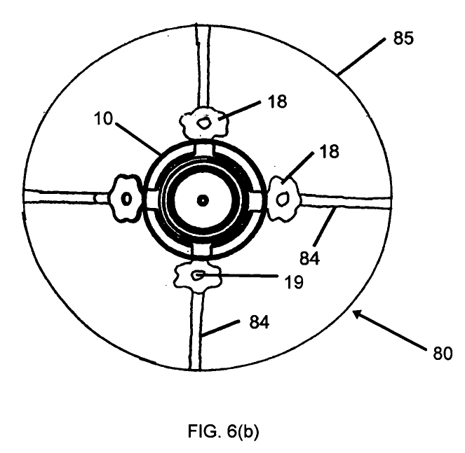

According to another embodiment of the invention, a perch 40 may be connected to the outside of the bottom of the bottle cap 10 as illustrated in FIG. 5. The perch 40 has a stem 42 which extends down from the bottom of the bottle cap 10. A first end of the stem 42 may be connected to the bottom of the bottle cap in a variety of manners, for example, snap onto projections 43 on the bottom of the bottle cap 10, two sided adhesive, glue, snap into a groove in the bottom of the bottle cap 10, etc., and the invention is not limited thereto. The second end of the stem 42 has a horizontal stand 44 on which a bird may stand when feeding from the feeding port 21. It will be understood that the perch 40 may have multiple stems 42 and horizontal stands 44 so as to provide a stand for each feeding port as illustrated in FIG. 6(a). In FIG. 6(a), the perch 40 has a hub 45 which connects to the projections 43 on the bottom of the bottle cap 10. Two stems 42 extend out from the hub 45 so that a horizontal stand 44 is properly positioned relative to each feeding port 21. In the alternative as illustrated in FIG. 6(b), the perch 80 has a hub which connects to the projections 43 on the bottom of the bottle cap 10. A first end of the hub may be connected to the bottom of the bottle cap in a variety of manners as described above. The second end of the hub is attached to a plurality of spokes 84 which radiate out from the hub. The plurality of spokes 84 support an outer ring 85. In use, birds can stand on the outer ring 85 and access the nectar through the openings 19 in the simulated attractors 18.

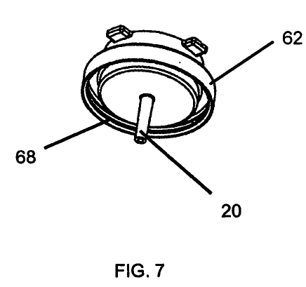

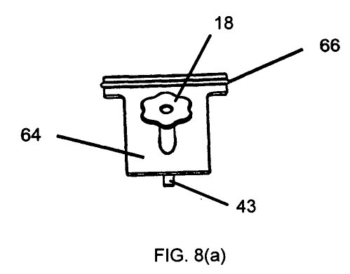

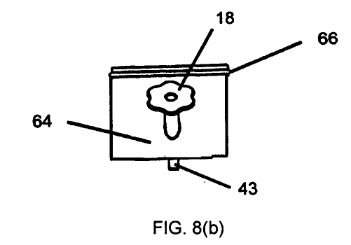

The bottle cap 10 and all of its components are preferably made of plastic, but the invention is not limited thereto and may be partially or completely made of other materials, such glass, metal, ceramic, etc. The bottle cap 10 and all of its components may be a single piece of plastic, formed through, for example, an injection and/or blow molding process, or be formed of multiple pieces which are connected together and the invention is not limited thereto. Preferably, the bottle cap 10 is comprised of two pieces 62 and 64 as illustrated in FIGS. 7-8. The first piece 62 comprises the first fluid chamber 15, the extension tube 20. The second piece 64 comprises the second chamber 16 and the feeding port 21. In this embodiment, the second piece 64 has a raised rib 66 which snaps into a groove 68 in the first piece 62 but the invention is not limited thereto.

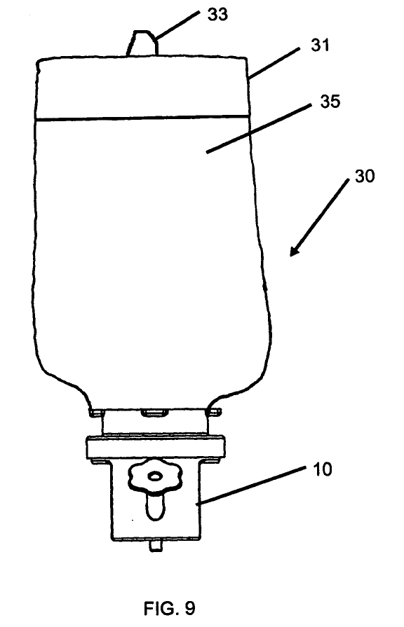

In use as part of a hummingbird feeder 30, the bottle cap 10 is attached to a bottle 31 which is filled with a nectar 35 as illustrated in FIG. 9. The threads 14 (shown in FIG. 1) of the bottle cap 10 mate with the threads of the bottle 31 and the bottle cap 10 is screwed onto the bottle. According to one embodiment of the invention, the bottle cap 10 is reusable and can be attached to any bottle 31 with a standard sized mouth. For example, many commonly used plastic bottles for soda, water, juice, etc., have standard sized mouths and can be used with the bottle cap 10 to form the hummingbird feeder 30. In this embodiment, the user pours the nectar 35 into the bottle 31 and screws on the bottle cap 10 and hangs the feeder from a hanging device 33. When the nectar is gone, goes bad or the feeder needs to be cleaned, the user can simply remove the cap and throw away the bottle 31. After cleaning the bottle cap 10, the user can fill a different (clean) bottle with the nectar and then attach the bottle cap 10. This invention substantially reduces the amount of time spent cleaning the feeder 30.

According to another embodiment of the invention, the feeder 30 with the bottle 31 and the bottle cap 10 can be sold to the user pre-filled with nectar. In this embodiment where the feeder 30 is completely disposable, the feeding ports 21 and the vent hole 50 are sealed by a sealant film or plug to prevent the feeder 30 from leaking prior to use. In use, the feeder 30 may have a hook or loop 33 to which a rope, string or a chain can be attached to allow the feeder 30 to be hung. Alternatively, the feeder 30 may be hung using some other hanging device. For example, the feeder 30 may be enclosed by a hanging device which shields part or all of the feeder from the sun. In this embodiment, when the feeder 30 needs to be cleaned, the entire feeder 30 is thrown away and a new feeder 30 is then used. Thus, the hassle of cleaning the feeder 30 is completely eliminated.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A bottle cap for fitting on a mouth of a bottle, comprising:
a first chamber with a opening for receiving the mouth of the bottle and a bottom, wherein threads are provided on an inner wall of the first chamber so that the cap can be screwed onto the mouth of the bottle;
a second chamber with a closed bottom;
an extension tube extending from the bottom of the first chamber at least partially into the second chamber, wherein liquid moves between the first and second chambers through the extension tube;
at least one feeding port in a side wall of the second chamber; and
at least one vent hole in the second chamber for allowing air to be vented from the second chamber.

2. The bottle cap according to claim 1, wherein said bottle cap is constructed of at least one of the following materials: plastic, glass, metal and ceramic.

3. The bottle cap according to claim 1, wherein the feeding port comprises at least one simulated attractor with at least one opening so as to provide access to liquid in the second chamber.

4. The bottle cap according to claim 3, wherein the feeding port further comprises a hollow stem connected from the second chamber to the simulated attractor so as to allow fluid to move at least a portion of the distance to the opening in the simulated attractor.

5. The bottle cap according to claim 3, wherein the simulated attractor is a simulated flower or other ornamental shape.

6. The bottle cap according to claim 4, wherein the hollow stem is angled upward from the bottom of the second chamber.

7. The bottle cap according to claim 4, wherein the hollow stem is either cylindrical or elliptical in shape.

8. The bottle cap according to claim 4, wherein the hollow stem has sufficient length to keep fluid from flowing out of the opening in the simulated attractor.

9. The bottle cap according to claim 1, wherein the vent hole is located at the top of the second chamber.

10. The bottle cap according to claim 3, wherein the vent hole is located in the second chamber at a height which is higher than the at least one opening in the simulated attractor.

11. The bottle cap according to claim 1, wherein the bottle cap has a plurality of stabilizing fins for holding the bottle in a proper position when the bottle is inserted into a hanging device.

12. The bottle cap according to claim 1, wherein the bottle cap has a two piece construction wherein the second chamber snaps onto the first chamber.

13. The bottle cap according to claim 1, further comprising:
a perch mounted onto the bottom of said bottle cap.

14. A bottle cap for fitting on a mouth of a bottle, comprising:
a first apparatus comprising:
a first chamber with a opening for receiving the mouth of the bottle and a bottom, wherein threads are provided on an inner wall of the first chamber so that the cap can be screwed onto the mouth of the bottle;
an extension tube extending from the bottom of the first chamber at least partially into the second chamber, wherein liquid moves between the first and second chambers through the extension tube;
at least one vent hole in the second chamber for allowing air to be vented from the second chamber;
a second apparatus comprising:
a second chamber with a closed bottom;
at least one feeding port in a side wall of the second chamber.

15. The bottle cap according to claim 14, wherein the second apparatus snaps into a groove in the first apparatus.

16. The bottle cap according to claim 14, wherein the feeding port comprises at least one simulated attractor with at least one opening so as to provide access to liquid in the second chamber.

17. The bottle cap according to claim 16, wherein the feeding port further comprises a hollow stem connected from the second chamber to the simulated attractor so as to allow fluid to move at least a portion of the distance to the opening in the simulated attractor.

18. The bottle cap according to claim 16, wherein the hollow stem is angled upward from the bottom of the second chamber.

19. The bottle cap according to claim 14, wherein the at least one vent hole is located at the top of the second chamber.

20. The bottle cap according to claim 16, wherein the vent hole is located in the second chamber at a height which is higher than the at least one opening in the simulated attractor.

21. The bottle cap according to claim 14, wherein the first apparatus has a plurality of stabilizing fins for holding the bottle in a proper position when the bottle is inserted into a hanging device.

22. A bird feeder, comprising:
a fluid reservoir and a mouth;
a first chamber with a opening for receiving the mouth of the bottle and a bottom, wherein threads are provided on an inner wall of the first chamber so that the cap can be screwed onto the mouth of the bottle;
a second chamber with a closed bottom;
an extension tube extending from the bottom of the first chamber at least partially into the second chamber, wherein liquid moves between the first and second chambers through the extension tube;
at least one feeding port in a side wall of the second chamber; and
at least one vent hole in the second chamber for allowing air to be vented from the second chamber.

23. The bottle cap according to claim 22, wherein the at least one vent hole is located at the top of the second chamber.

24. The bottle cap according to claim 16, wherein the vent hole is located in the second chamber at a height which is higher than the feeding port.
